(19) United States
(12) Patent Application Publication
(10) Pub. No.: US 2004/0233929 A1
(43) Pub. Date: Nov. 25, 2004

(54) System and method of controlling network devices

(76) Inventors: Tobin J. Hall, Longview, TX (US); Marc C. R. Bally, Longview, TX (US); Daniel R. Smith, Hallsville, TX (US)

Correspondence Address: HAYNES AND BOONE, LLP, 901 MAIN STREET, SUITE 3100, DALLAS, TX, 75202, US

(21) Appl. No.: 10/764,708

(22) Filed: Jan. 26, 2004

Related U.S. Application Data
(60) Provisional application No. 60/442,933, filed on Jan. 27, 2003.

(51) Int. Cl. H04J 15/00

(52) U.S. Cl. 370/464

(57) ABSTRACT

A network comprises a plurality of nodes, a first communications path coupling the plurality of nodes, the first communications path formed by node-to-node links. The network further comprises a second communications path coupling the plurality of nodes, the second communications path formed by a data bus.

### BACKGROUND

Lighting, security, heating and cooling (HVAC), and other devices have been networked to enable the user to control their operations using a control panel or remote control device. These networks employ a centralized control architecture using a central controller that functions as a master controller. The master controller receive user input and sends control commands to the various network nodes to change their states. If a user asks to dim multiple lights, for example, the master controller sends multiple control messages to the network nodes associated with the lights that need to be dimmed. A disadvantage of this centralized architecture is the possibility of failure of the entire network and the devices it controls due to a failure at the master controller. Further, it is undesirable to process all requests at the central controller that creates the potential for a processing and data transfer bottleneck. Other distributed solutions rely on a powerline carrier, for example, to communicate control and data information. However, these solutions are often unreliable and unpredictable.

### BRIEF DESCRIPTION OF THE DRAWINGS

FIG. 1 is a simplified schematic diagram of an embodiment of a system for controlling network devices;

FIG. 2 is a simplified block diagram of an embodiment of a network node;

FIG. 3 is a simplified block diagram of an embodiment of a bus module of a network node;

FIG. 4 is a more detailed block diagram of an embodiment of a bus module of a network node;

FIG. 5 is a simplified flowchart of an embodiment of a setup process for configured network nodes;

FIG. 6 is a simplified flowchart of an embodiment of a setup process for un-configured network nodes;

FIG. 7 is a simplified flowchart of a process of receiving input at a network node;

FIG. 8 is a simplified flowchart of an embodiment of a static behavior process of a network node; and

FIG. 9 is a simplified flowchart of an embodiment of a dynamic behavior process of a network node.

### SUMMARY OF THE INVENTION

In an embodiment of the invention, a network comprises a plurality of nodes, a first communications path coupling the plurality of nodes, the first communications path formed by node-to-node links. The network further comprises a second communications path coupling the plurality of nodes, the second communications path formed by a data bus.

In another embodiment of the invention, a network comprises a plurality of nodes, some nodes operable to receive input and some nodes operable to provide output. The network further comprises a communications path coupling the plurality of nodes, and at least one node receiving an input is operable to behave in a predetermined manner and to broadcast a message to other nodes, and other nodes are operable to behave in the predetermined manner in response to receiving the message.

In yet another embodiment of the invention, a method of controlling a plurality of nodes in a network comprises receiving an input at one of the plurality of nodes, determining a behavior associated with the received input, broadcasting the behavior to the plurality of nodes, whereby nodes identifying with the behavior perform the behavior, and performing the behavior associated with the received input.

In yet another embodiment of the invention, a method of configuring a plurality of nodes in a network comprises powering up the nodes in the network, issuing, by a configuration master node, a configuration start command to the plurality of nodes on a network coupling the nodes, and sending, by a configuration master node, a setup start pulse to a first node coupled to the configuration master node by a node-to-node link. At each node, a next available macro number is sent to the plurality of nodes, a setup start pulse is relayed to a next node on the node-to-node link, and a setup complete pulse is returned in response to receiving a setup complete pulse from the next node. The method further comprises issuing, by a configuration master node, a configuration complete command in response to receiving a setup complete pulse from the first node.

In yet another embodiment, a network comprises a plurality of nodes, a first communications path coupling the plurality of nodes, the first communications path formed by node-to-node links, and a second communications path coupling the plurality of nodes, the second communications path formed by a data bus. The network further comprises a behavior table residing at each of the plurality of nodes. The behavior table identifies at least one behavior associated with at least one macro number. The plurality of nodes receives commands on the second communications path and performs behaviors according to the behavior table in response to receiving a command containing a macro number in the behavior table.

### DETAILED DESCRIPTION

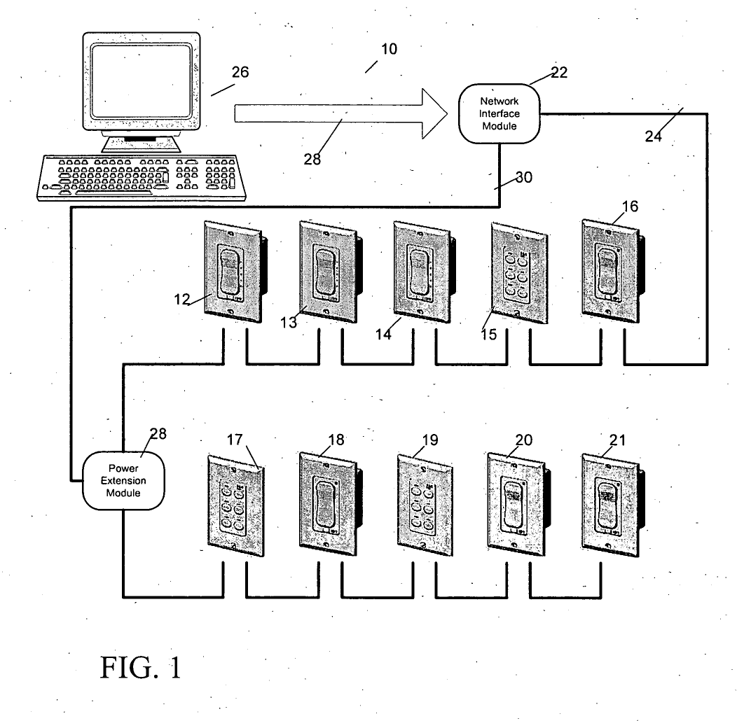

FIG. 1 is a simplified schematic diagram of an embodiment of system 10 for controlling network devices 12-21. Devices 12-21 may include on/of switches, dimming switches, multi-button switches, control panels, and other user interfaces operable to changing the state of a controlled appliance. A controlled appliance may include lighting equipment, multimedia components, security equipment, cooling and heating and other devices that contribute to some aspect of a user's environment. Devices 12-21 are coupled in a daisy-chain like manner to one another and to a network interface module 22 via a data cable 24. Two communications paths are formed in data cable 24, one a node-to-node link and another a data bus.

Network interface module 22 may be optionally coupled to a computer 26 via a second communication link 28, such as a serial RS-232 link. Computer 26 may include any computing device that incorporates a microprocessor for carrying out computer instruction codes. Computer 26 may include a laptop computer, a notebook computer, a desktop computer, or other computing devices now known or later developed. As an option, a user may use a computer 26 to program the network nodes. A power extension module 28 may be used to extend the daisy chain to include additional devices. Power extension module 28 may be coupled to network interface module 22 via a power cable 30.

In operation, control messages are transmitted by the two communications paths in data cable 24 to network devices 12-21. The node-to-node link may use a low speed but reliable protocol. A communication protocol, such as one employing command pulses of varying lengths, may be used. Because each link connects between two nodes, no addressing is needed. The data bus may use a high-speed communication protocol that transmits data packets to all the nodes. Both communications paths are used in diagnostics to detect failures. A communication protocol such as RS-485 may be used to communicate messages or data packets addressed to the devices. Details of the communication protocols are described below. In the event of power outage, electrical storm or other problems, system 10 is isolated from the powerline due to the use of network interface module 22. An uninterruptible power supply or UPS can be used to maintain power to network interface module 22 and devices 12-21.

Each node on the network process data packet it receives to determine if it needs to respond to it or act in some predetermined manner. Each device also in effect function as a “sensor” that is operable to detect or receive user input so that the network may respond in some predetermined manner. Behaviors may also be “learned” by the nodes in the network.

A user may program the network so that multiple devices are bound together so that they respond substantially similarly and simultaneously to a stimulus. For example, when a device is actuated by a user, such as when a button on a switch has been pressed, the device sends a broadcast message to all the other devices on the network. This broadcast message includes a macro number associated with the actuated device. If another device on the network is bound to the same macro number in the broadcast message, then it also responds in the same manner as the actuated device. Multiple devices on the network may also “learn” to associate behaviors with a button designated as a scene button. Upon actuation of the scene button, other devices associated with this scene button respond accordingly, such as turning off a light, dimming some lights to 20%, and dropping a projector screen, for example.

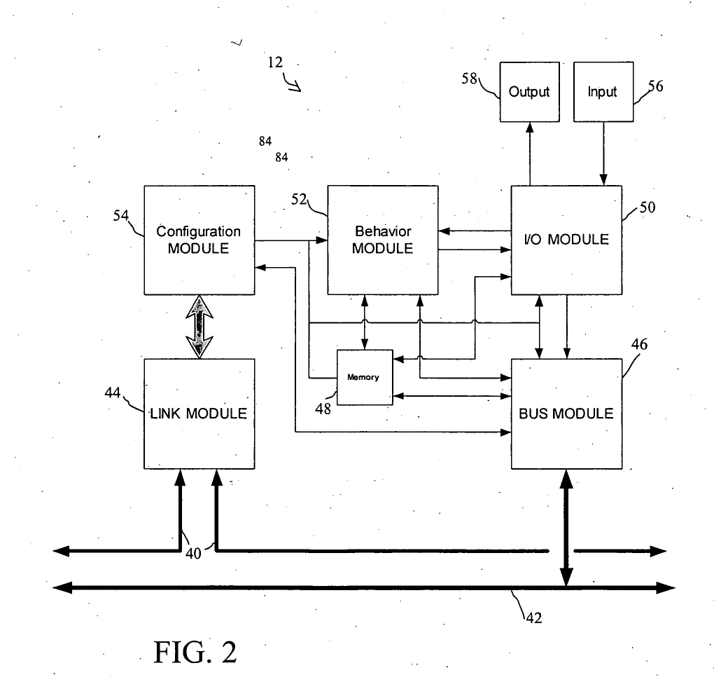

FIG. 2 is a simplified block diagram of an embodiment of a network node 12, which is a device on the network. The network includes two communications paths, a node-to-node link 40 and a bus 42. Communications path 40 is a reliable link that connects network nodes in a daisy-chain like manner. Communications path 40 is used to configure and address communications path 42, and may employ a low speed protocol that does not use addressing. On the other hand, communications path 42 may employ RS-485 protocol and a packet message format with addressing to communicate with the network nodes. Both communications paths may reside physically in a common cable, such as a Category (CAT) 5 or 3 cable. For example, communications path 40 may be carried over a wire in the CAT 5 cable, and communications path 42 may be carried over a twisted pair wire in the same CAT 5 cable. Details of the communication protocols are described below.

Network node 12 interfaces with communications path 40 via a link module 44, and with communications path 42 via a bus module 46. Link module 44 includes two transceivers that each couples to a neighboring node. Either transceiver at either end of each communications path 40 may pull the line down for communicating data. Communication on path 40 uses command pulses of varying lengths. A ping or attention command is used to determine if the link terminates at another node and is also used preface all commands. Command pulses that have been received are responded with command acknowledgement pulses. Command pulses may be sent in either direction down the path. A network node acquires a static address that is according to its place in the network, which is also related to the order in which it is configured upon power-up. The static address is therefore automatically assigned at power-up and remains unchanged. The static addresses may be stored in a memory 48, which may be a non-volatile memory or any other suitable memory device. A node that is inserted into the network at a later time is automatically assigned a new unique static address so that no modification to other existing nodes is necessary.

Bus module 46 serves as the interface between the network node and communications path 42. Communications path 42 may employ a protocol in which packets of fixed or varied lengths are transmitted. Many commands transmitted on communications path 42 are broadcast to all nodes on the network. In addition to the static address, a network node is also given a dynamic address that is not related to the node's physical relationship to the other nodes. Dynamic addresses are referred to as macro numbers and are used in data packets transmitted communications path 42. Macro numbers can be used to “bind” multiple devices so that they respond substantially simultaneously to a given stimulus. More than one device or node may have the same macro number, and a node may respond or act in response to more than one macro number.

Bus module 46 is further in communication with an I/O module 50, a behavior module 52, and a configuration module 54. I/O module 50 is operable to interface with an input device 56 and an output device 58. Input device 56 may include one or more buttons or switches, a control panel, and other devices that a user may manipulate. Output device 58 may include a load (lighting, HVAC, security equipment, etc.) and/or a visual or audio indicator that provides feedback to the user. Visual indicators may include one or more light emitting diodes (LED) and liquid crystal display (LCD) screen, and audio indicators may include an alarm, a beep, etc.

Configuration module 54 is operable to configure and verify a network node. Configuration module 54 may acquire an address, verify an address, acquire a resource such as a macro, and initializing a behavior table for that device. Each network node has its own behavior table containing the macro numbers the node may respond to and the behavior associated with the macros. On power-up, network interface module 22 or another node designated by network interface module 22 (FIG. 1) functions as a configuration master. Network interface module 22 may pull the level of communication path 40 to indicate to the first node on the line that it should act as the configuration master node. The configuration master node preferably uses both pathways 40 and 42 in the configuration process. The configuration process is automatically carried out upon power-up. The configuration master node waits for all nodes to power up and sends a configuration start command down the daisy chain of networked nodes using bus 42. It then command all nodes in the network to go off-line using node-to-node link 40 and initializes all configured nodes down the line by sending command pulses down node-to-node link 40. The configuration master node then initializes and configures all un-configured nodes down the line by sending command pulses down node-to-node link 40. The master node then indicates configuration is complete by sending a command down bus 42 and brings all the nodes back online using node-to-node link 40.

During configuration, each object is initially assigned its own unique macro number. However, a user may alter the macro number assignment by “binding” multiple devices together with the same macro number. When the object is acted upon by an outside force, such as a button press, it broadcasts this activity to other nodes in the network in the form of a MACRO command, which includes its macro number. Because multiple devices or objects may have the same macro number, all objects with the same macro number respond simultaneously to the same MACRO command. A macro master may be assigned for each macro during configuration. A prioritizing scheme may be used to designate one device as the master of a macro claimed by multiple devices. For example, a dimmer may have higher priority than a relay, which has higher priority than a multi-button device, for example.

Behavior module 52 of each network node is operable to respond to stimulus received on bus 42 at each node. A stimulus such as a MACRO command comprises a macro number and data associated therewith. Behavior module 52 looks up a rule to process the data associated with the macro number, and then decide how to act in response to the MACRO command.

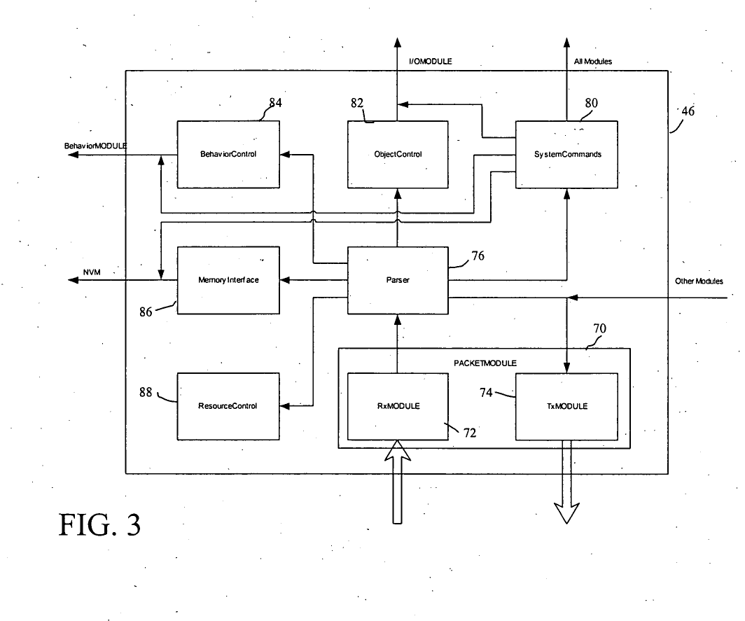

FIG. 3 is a more detailed block diagram of an embodiment of bus module 46. Input and output from bus 42 are processed by packet module 70, which includes a receive (Rx) module 72 and a transmit (Tx) module 74. A parser 76 is operable to receive packets received from bus 42 and determine what commands and data are received. The packets may include a start byte, a length field, a data field, an end byte, and a checksum field. The data field may include one or more commands and one or more data parameters. The data parameters may include node address, macro number, objet, data type, node type, data, and number of bytes. An object in system 10 is something that can be manipulated, such as an input or an output device. For example, an object may be a button and a LED in a multi-button switch, a relay, a LED, a pair of buttons in an on/off switch, a dimmer, buttons and a LED panel, or a switch and sensor. Each object is assigned a macro, which is used to report the state of the object and whether the object is acted upon. Depending on what was in the received packet, the parsed information therefrom is divided into several command types: system commands 80, object control 82, behavior control 84, memory interface 86, and resource control 88.

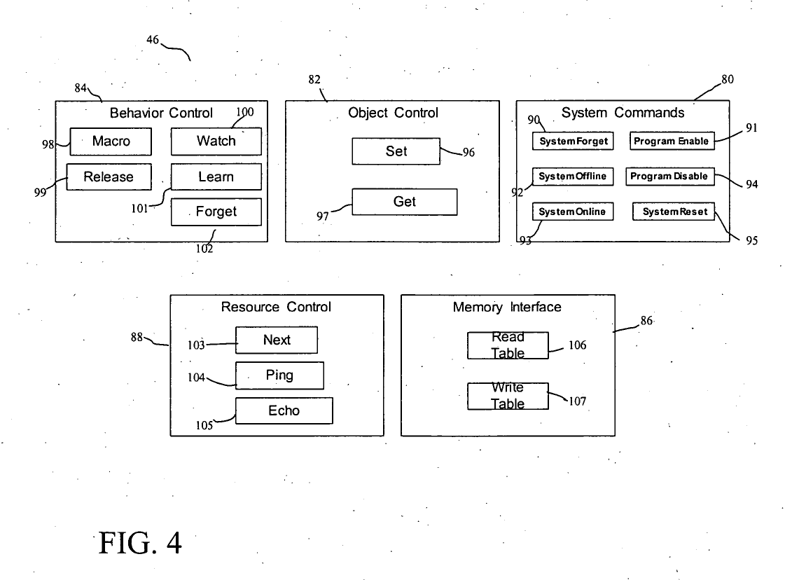

Referring to FIG. 4, system commands 80 include a plurality of commands associated with the system. For example, system commands may include system forget 90, system enable 91, system offline 92, system online 93, program disable 94, and system reset 95 commands. Object control 82 includes a SET command 96 to set an object in a given node to a given value, and a GET command 97 to get the value of an object.

Behavior control 84 may include a MACRO command 98 to indicate that a button or object associated with the macro has been pressed or activated, and a RELEASE command 99 to indicate that a button or object associated with the macro has been released. Multiple objets may share the same macro number so that they respond similarly to the same stimulus. This may be accomplished by putting multiple devices in programming mode at the same time. Putting a device or button in programming mode may comprise pressing and holding that button for a predetermined period of time until a visual response indicates programming mode, for example. Actuation of any bound device would lead to the same response of that device as well as other devices that are bound thereto.

Behavior control 84 further includes a WATCH command 100 to start a learning process that programs devices in the system. Programming mode is initiated by sending the WATCH command from a given object with a given macro number and data value. This announces to the system that the behavior for that macro number with this data value is being learned. The behavior for that given macro number is then received and recorded. For example, the user may begin by putting a particular device in programming mode, which will serve as the scene device or button. The WATCH command is broadcasted to other nodes. When the user turns ON a particular switch and dims a particular light, for example, these behaviors are associated with the macro number associated with the scene button. The object then announces that learning is complete by sending the LEARN command 101. Objects of different data types and values may track or respond to one another. For example, a binary or multi-bit device may respond to a binary device. When the binary device is ON, the responding device can be ON or OFF for a binary device or a particular value for the multi-bit device. A multi-bit device may learn to respond to another multi-bit device, where the value learned is an extrapolation of all data values from zero to the value learned. A binary device may also respond to a multi-bit device, where a macro received above the threshold data value turns ON the binary device and OFF for values below the threshold. The FORGET command 102 is used to tell network nodes to forget all bindings and scenes related to a certain macro given in the command packet.

Resource control 88 includes a NEXT command 103 that is used in setup to reserve resources on the network. Resource control 88 further includes a PING command 104 to ping a node, and an ECHO command 105 to respond to the PING command. Memory interface 86 includes a READ TABLE command 106 and a WRITE TABLE command 107 to access a behavior table storing actions for a given stimulus.

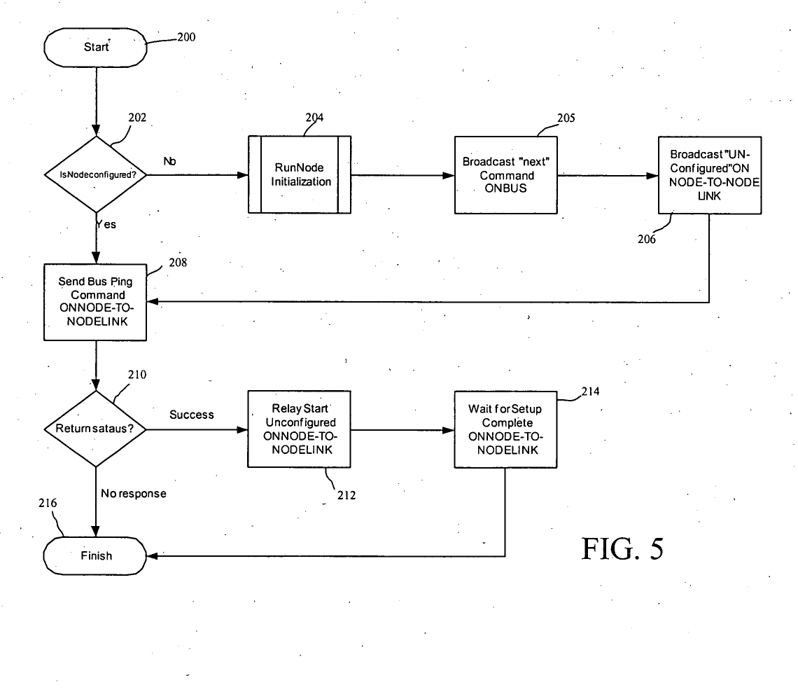

FIG. 5 is a simplified flowchart of an embodiment of a process 200 for setting up configured nodes. As described above, configuration is initiated by a configuration master node upon power-up. Both communication paths 40 and 42 are used during configuration. In block 202, a determination is made as to whether the node is configured. If the node is configured, a NEXT command with the next available node address and macro number is broadcasted on bus 42 in block 204. The NEXT command is used to reserve node addresses and macro numbers. A node that receives this command compares the node number and macro number in the command to the node number and macro number it previously received from other NEXT commands. A CONFIGURED command is then broadcasted on bus 42 in block 206 to indicate that the current node has completed configuration, and execution proceeds to block 208. If the node is not configured, as determined in block 202, a bus PING command is sent down node-to-node link 40 in block 208. In block 210, the status of the PING response is determined. If the returned status is a success, then a CONFIGURED SETUP START command pulse to start the configured node setup process is sent on node-to-node link 40 in block 212. If a node is new in the network, it just passes the command on to the next node. This command is relayed all the way down the node-to-node link to all the network nodes. In block 214, execution waits for the SETUP COMPLETE command pulse to come back, which is relayed back in the other direction. The receipt of a SETUP COMPLETE command pulse indicates to the receiving node that it and all other nodes down the line are set up. If the returned status in block 210 is no response, execution ends in block 216. An error indicator may be used in the case of a failed set up process.

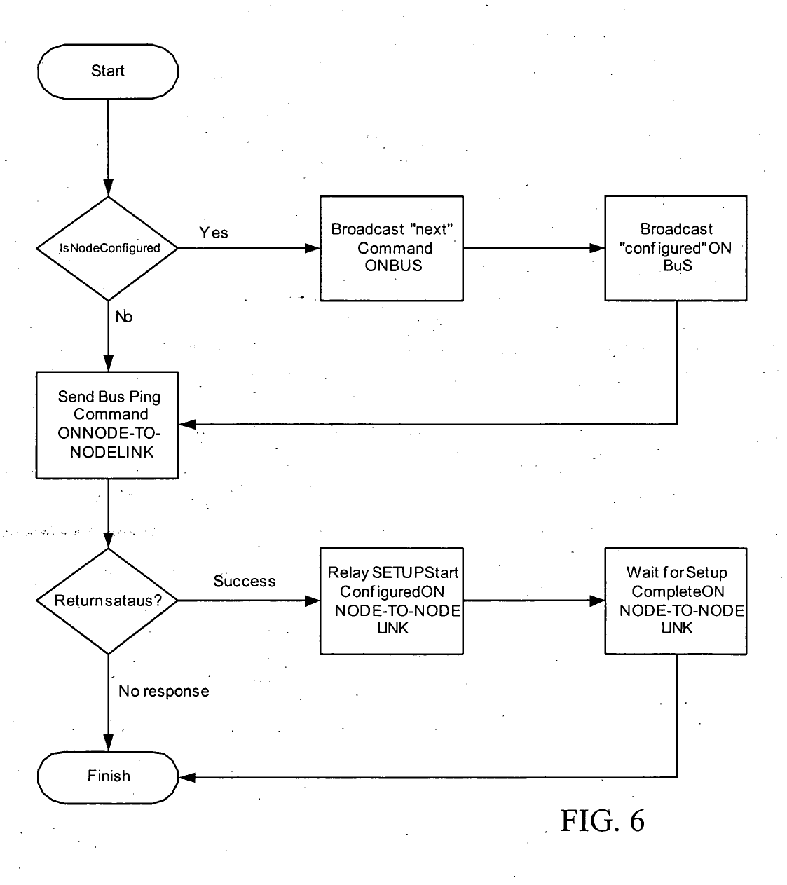

FIG. 6 is a simplified flowchart of an embodiment of a process 220 for setting up a un-configured or new node. An un-configured node may be a device that is inserted into the network after the network has already been setup. In block 222, a determination is made as to whether the node is configured. If the node is not configured, then a node initialization process is started in block 224. In block 226, a NEXT command is broadcasted on bus 42 and a UNCONFIGURED command is then broadcasted on bus 42 in blocks 226 and 228, and execution proceeds to block 230. If the node is configured, as determined in block 222, a bus PING command is sent down node-to-node link 40 in block 230. If a node is already configured, it just passes the command on to the next node. This command is relayed all the way down the node-to-node link to all the network nodes. In block 232, the status of the PING response is determined. If the returned status is a success, then a command pulse to start the un-configured node setup process is sent on node-to-node link 40 in block 234. In block 236, execution waits for the setup complete command pulse until it is received. If the returned status in block 232 is no response, execution ends in block 238.

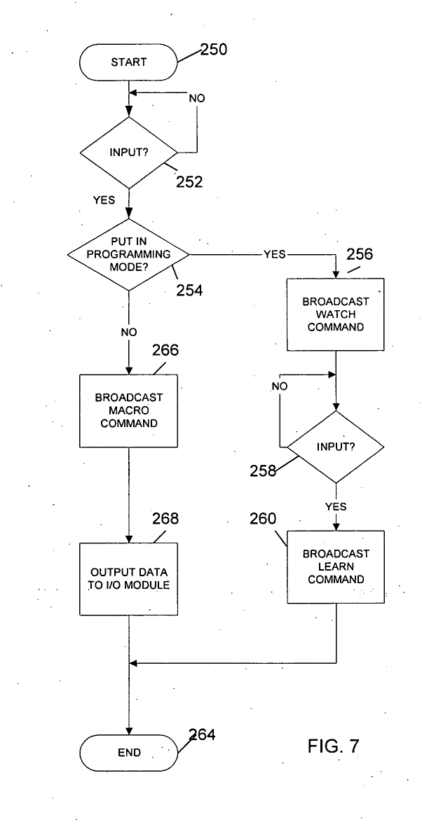

FIG. 7 is a simplified flowchart of an embodiment of a process 250 of receiving and processing an input at a network node. In block 252, the node waits for a user input. An input may be a button press, a switch flipped, a selection from a menu displayed on a screen, for example. Upon receiving an input, a determination is made as to whether the input indicates entry into programming mode in block 254. If the input does indicate programming mode, then a WATCH command is broadcast to other network nodes in block 256 so that the other network nodes will watch their current state, and if it changes, to record the changes. These changes represent a scene that the network will present when a command with the same macro number is received in the future. In block 258, upon receiving any additional input, a LEARN command is broadcast to all other network nodes in block 260 to indicate the completion of the learning process. Execution then proceeds to block 264.

If in block 254, it is determined that the input does not indicate programming mode, then the macro number associated with the node or object is broadcast to other network nodes in block 266 in the form of a MACRO command. The MACRO command includes the macro number. The behavior data associated with the input or the macro number is then provided to I/O module 50 to be carried out in block 268 in the current network node. Execution ends in block 264.

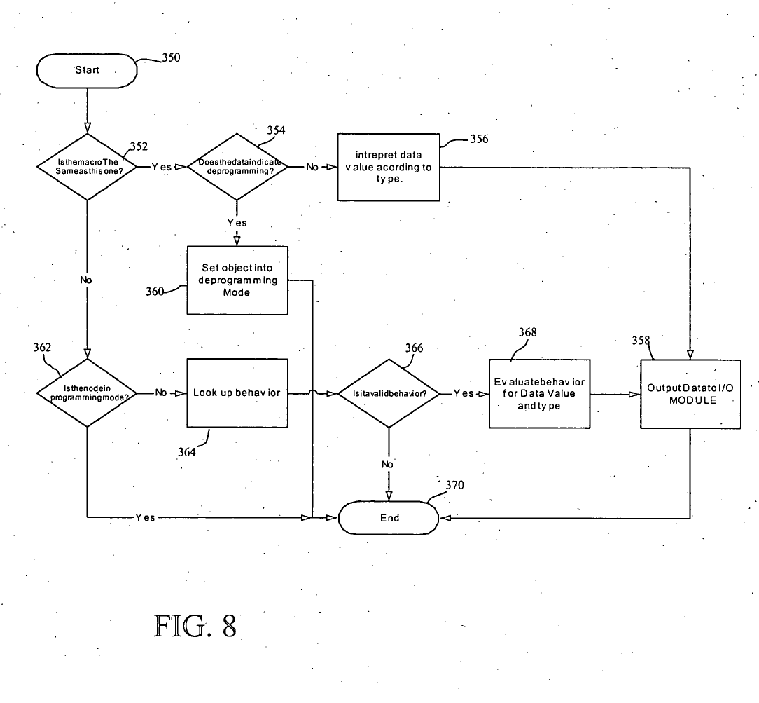

FIG. 8 is a simplified flowchart of an embodiment of a process 350 of controlling a static behavior of an object. Static behavior controls the final resting value of an object. As discussed above, a network node may have multiple objects associated therewith, such as a multi-button switch. In block 352, a determination is made as to whether the received data packet contains the macro number matching the macro number that the object(s) in the node will respond to. In other words, the object bound to this macro number or has the same macro number. If yes, then the data parameters in the packet are examined to determine whether they indicate deprogramming in block 354. For example, if the data type in the packet is set to Z, it is indicative of no data and deprogramming is intended. If it is not deprogramming, then the current object is bound to the object that sent the MACRO command and should mimic the behavior indicated in the data packet. The data value in the data packet is therefore interpreted appropriately in block 356, and the data is provided to the I/O module in block 358 to be carried out.

If in block 354 it is determined that deprogramming is desired, then the object is put in deprogramming mode in block 360. If in block 352 it is determined that the macro is not the same, then a determination is made as to whether the node is in programming mode in block 362. If the node is not in programming mode, then the behavior associated with the macro number is determined by consulting a behavior rule lookup table, for example, in block 364. A determination is made as to whether the behavior is valid in block 366. If the behavior is not valid, then an optional error indication may be given and execution ends in block 370. If the behavior is valid, then the behavior is evaluated in light of the data value and data type in the received packet in block 368. The data is then output to the object module in block 358 to be carried out.

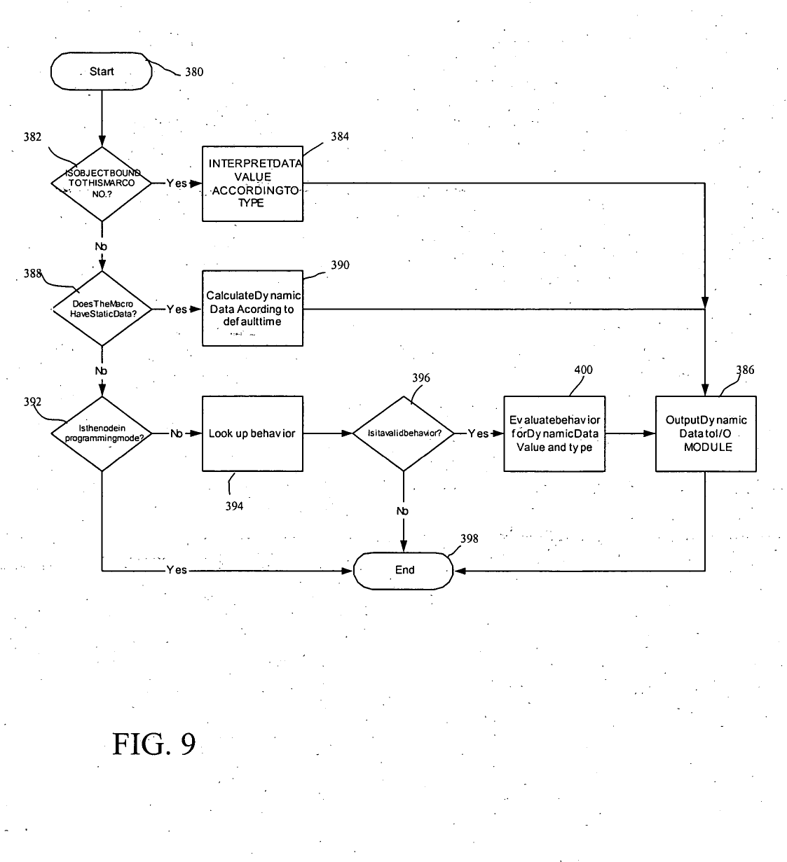

FIG. 9 is a simplified flowchart of an embodiment of a process 380 of controlling a dynamic behavior of an object. Dynamic behavior controls the rate of change of an object. When acting in concert, multiple devices on the network may change their state at the same rate using dynamic control. In block 382, a determination is made as to whether the received MACRO command contains a macro number that the object is bound to. If the object is bound to the macro number, then the data value is interpreted according to the data type in block 384. For example, the data type may be a static dimmer position data type, a dimmer change-of-rate increase data type, or a dimmer change-of-rate decrease data type. The data value is provided as output to I/O module in block 386. If the object is not bound to the macro number, then a determination is made as to whether the command contains static data in block 388. If the packet contains static data, then a dynamic value or rate of change is computed according to a default time in block 390. For example, if the static data value is 100% and the current dimmer value is set at 0%, a change-of-rate is computed for changing the dimmer value in a default time of three seconds.

If the macro does not have static data, then a determination is made as to whether the node is in programming mode in block 392. If the node is not in programming mode, then the behavior associated with the macro is determined by consulting a behavior rule lookup table associated with the object in block 394. A determination is made as to whether the behavior is valid in block 396. If the behavior is not valid, then an optional error indication may be given and execution ends in block 398. If the behavior is valid, then the behavior is evaluated in light of the dynamic data value and data type in the received packet in block 400. The data is then output to the I/O module in block 386 and execution ends in block 398.

It may be seen that upon power-up, a network node acting as a configuration master automatically configures the nodes in the network. The nodes are assigned their static addresses automatically according to its position in the network. Network nodes only send data on the bus when their state changes, such as when a button associated therewith has been pressed so that it is going from ON to OFF. The MACRO command may be used to broadcast this to all the nodes in the network. If that button or object is associated with a macro number that is a number of other objects or devices on the network are also bound to, they will respond to the MACRO command appropriately by mimicking the activity of the button being pressed. Therefore, by using dynamic addressing where multiple objects may share a common macro, multiple devices on the network may be bound together to act substantially identically and simultaneously. For example, all the light switches may be programmed to respond to one button press to either be in the full ON position or full OFF position. Because each device in the network in effect act as a sensor, i.e. it receives or detects input, and broadcasts the received input to all other nodes in the network with its macro number, other nodes in the network with the same macro number can respond to the same received input. It may be seen that the received input may be an actual physical input such as pressing or releasing a button, or it may be a virtual input issued by a computer or controller.

Multiple devices may also be programmed to present a scene. For example, a button press may set certain light switches to a dimmed value, another set of light switches to OFF, and the room temperature to a predetermined degree for optimal movie viewing in a media room. Scene programming and device binding may be done without additional tools or software, however a computer coupled to the network may be used to formulate and implement more complex scenes and bindings. The network nodes will respond to a physical actuation of a device, such as a button press, as well as a virtual button press that is implemented by broadcasting a MACRO command in the network. Upon receiving the MACRO command, an object may perform a table look-up to determine the behavior it should perform as part of a scene.

It may be seen that a network node may comprise a single object or multiple objects, such as buttons or switches associated with the same device. The description herein uses terms “node,” “object” and “device” somewhat interchangeably, but a clarification should be made that some commands may operate on a node level and others may operate on an object level. For example, the MACRO command is associated with an object such as a button and is sent when the button is actuated. Upon receiving a data packet, each object within a network node processes the command in parallel with other objects to determine whether it should act.

What is claimed is:

1. A network, comprising:
a plurality of nodes;
a first communications path coupling the plurality of nodes, the first communications path formed by node-to-node links; and
a second communications path coupling the plurality of nodes, the second communications path formed by a data bus.

2. The network, as set forth in claim 1, wherein the first communications path transmits command pulses of various lengths between two connected nodes.

3. The network, as set forth in claim 1, wherein the first communications path relays commands down successive nodes in the network.

4. The network, as set forth in claim 1, wherein the second communications path broadcasts data packets to the plurality of nodes.

5. The network, as set forth in claim 1, wherein the second communications path broadcasts a command containing a macro number associated with a desired behavioral response to the plurality of nodes.

6. The network, as set forth in claim 1, wherein the second communications path broadcasts a command containing a macro number to which at least one node will respond with a desired behavior substantially simultaneously.

7. The network, as set forth in claim 1, wherein each of the plurality of nodes comprises an input device.

8. The network, as set forth in claim 7, wherein each input device is associated with a macro number.

9. The network, as set forth in claim 8, wherein each input device is operable to broadcast a command with its macro number to other nodes in the network in response to receiving a predetermined input, and other nodes are operable to behave in a predetermined manner in response to receiving the command.

10. The network, as set forth in claim 1, wherein each of the plurality of nodes is assigned a unique static address.

11. The network, as set forth in claim 1, wherein the second communications path broadcasts a command containing a macro number to which at least one node will respond with a desired behavior at a desired rate of change.

12. A network, comprising:
a plurality of nodes, some nodes operable to receive input and some nodes operable to provide output;
a communications path coupling the plurality of nodes; and
at least one node receiving an input is operable to behave in a predetermined manner and to broadcast a message to other nodes, and other nodes are operable to behave in the predetermined manner in response to receiving the message.

13. The network, as set forth in claim 12, wherein each node is associated with a macro number and the macro number is contained in the broadcasted message.

14. The network, as set forth in claim 13, wherein each node is operable to broadcast a command with its macro number to other nodes in response to receiving a predetermined input, and other nodes having the same macro number are operable to behave in a predetermined manner in response to receiving the command.

15. The network, as set forth in claim 13, wherein each node is operable to broadcast a command with its macro number to other nodes in response to receiving a predetermined input, and other nodes having the same macro number are operable to behave in a predetermined manner substantially simultaneously in response to receiving the command.

16. The network, as set forth in claim 12, wherein the communications path broadcasts a command containing a macro number to which at least one node having the same macro number will respond with a desired behavior at a desired rate of change.

17. The network, as set forth in claim 12, further comprising a second communications path operable to transmit command pulses of various lengths between two connected nodes.

18. The network, as set forth in claim 12, wherein the plurality of nodes comprises ON/OFF switches.

19. The network, as set forth in claim 12, wherein the plurality of nodes comprises multi-position switches.

20. The network, as set forth in claim 12, wherein the plurality of nodes comprises multi-button switches.

21. The network, as set forth in claim 12, wherein the plurality of nodes comprises lighting equipment.

22. The network, as set forth in claim 12, wherein the plurality of nodes comprises heating and cooling equipment.

23. The network, as set forth in claim 12, wherein each of the plurality of nodes is assigned a unique static address.

24. A method of controlling a plurality of nodes in a network, comprising:
receiving an input at one of the plurality of nodes;
determining a behavior associated with the received input;
broadcasting the behavior to the plurality of nodes, whereby nodes identifying with the behavior perform the behavior; and
performing the behavior associated with the received input.

25. The method, as set forth in claim 24, further comprising broadcasting a macro number associated with the received input, and nodes identifying with the macro number are operable to perform the behavior.

26. The method, as set forth in claim 24, further comprising assigning a unique static address to each of the plurality of nodes.

27. The method, as set forth in claim 24, further comprising assigning an identical macro number to a plurality of nodes.

28. The method, as set forth in claim 27, further comprising:
receiving a command containing a macro number;
identifying the macro number;
determining and performing a behavior associated with the macro number in response to identifying the macro number.

29. The method, as set forth in claim 28, wherein identifying the macro number comprises locating the macro number in a lookup table.

30. The method, as set forth in claim 27, further comprising receiving a command containing a macro number, and performing a behavior associated with the macro number at a rate of change in response to identifying the macro number.

31. The method, as set forth in claim 29, further comprising computing the rate of change.

32. A method of configuring a plurality of nodes in a network, comprising:
powering up the nodes in the network;
issuing, by a configuration master node, a configuration start command to the plurality of nodes on a network coupling the nodes;
sending, by a configuration master node, a setup start pulse to a first node coupled to the configuration master node by a node-to-node link;
at each node, sending a next available macro number to the plurality of nodes, relaying a setup start pulse to a next node on the node-to-node link, and returning a setup complete pulse in response to receiving a setup complete pulse from the next node; and
issuing, by a configuration master node, a configuration complete command in response to receiving a setup complete pulse from the first node.

33. The method, as set forth in claim 32, further comprising assigning each node a unique static address.

34. The method, as set forth in claim 32, further comprising assigning each node a dynamic macro number.

35. A network, comprising:
a plurality of nodes;
a first communications path coupling the plurality of nodes, the first communications path formed by node-to-node links;
a second communications path coupling the plurality of nodes, the second communications path formed by a data bus; and
a behavior table residing at each of the plurality of nodes, the behavior table identifying at least one behavior associated with at least one macro number, wherein the plurality of nodes receives commands on the second communications path and performs behaviors according to the behavior table in response to receiving a command containing a macro number in the behavior table.

36. A method, comprising:
receiving a command having a macro number indicative of scene learning;
detecting a change-of-state;
associating the change-of-state with the macro number;
storing the macro number and the associated change-of-state;
receiving a command having the macro number; and
affecting the change-of-state.

37. The method, as set forth in claim 36, further comprising receiving a user input indicative of scene learning associated with a predetermined device associated with the macro number.
